(19) United States
(12) Patent Application Publication
(10) Pub. No.: US 2010/0040794 A1
(43) Pub. Date: Feb. 18, 2010

(54) PLACENTAL BLOOD EXTRACTOR

(76) Inventors: Francis Dobler, Drusenheim (FR); Giorgio M. Tuberga, Wadenswil (CH)

Correspondence Address: The Dow Chemical Company, Intellectual Property Section, P.O. Box 1967, Midland, MI, 48641-1967, US

(21) Appl. No.: 12/445,788

(22) PCT Filed: Nov. 15, 2007
(86) PCT No.: PCT/US07/84781

§ 371 Date: Apr. 16, 2009

Related U.S. Application Data
(60) Provisional application No. 60/859,219, filed on Nov. 15, 2006.

(51) Int. Cl. B05D 1/28; C08L 63/00

(52) U.S. Cl. 427/428.01; 524/500

(57) ABSTRACT

A placental blood extractor consists of an outside box having plurality of plastic bags for compressing the placenta and mounted to the top of the box. The lower part of the box has possibility to use several different circularly movable plates for mechanically facilitating the flow of the blood in the collecting veins on the fetal side of the placentas toward the central main umbilical cord vein. The box has an opening in the central lower part of the box and the lower area mechanical tray for the umbilical cord to exit the box. Blood is collected from umbilical cord and is to be collected into commercial collection bags. The area of the bag for collection of blood may be under negative pressure to facilitate the collection of blood but also gravity force may be used for that purpose. Both, the first part with the compression chambers as well as the second part, the Collector of Blood have pumps and manometers controlled by computer in their operations.

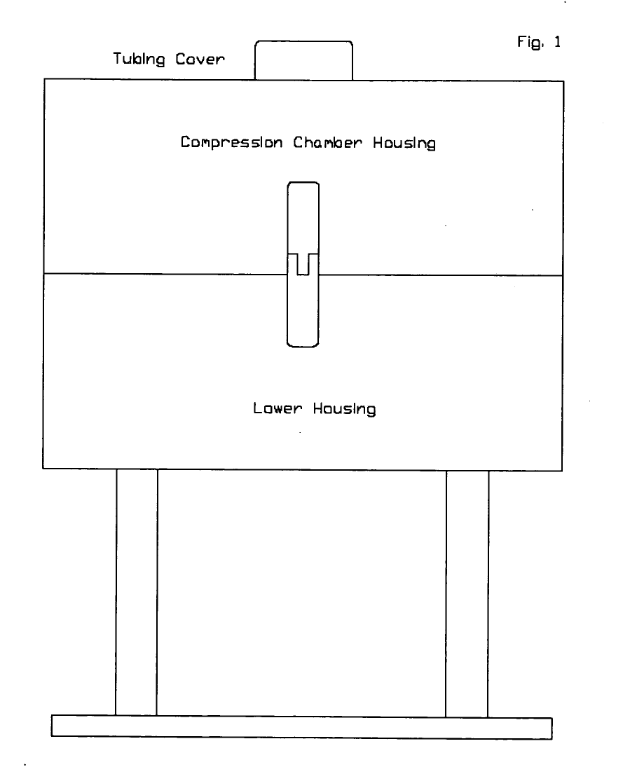

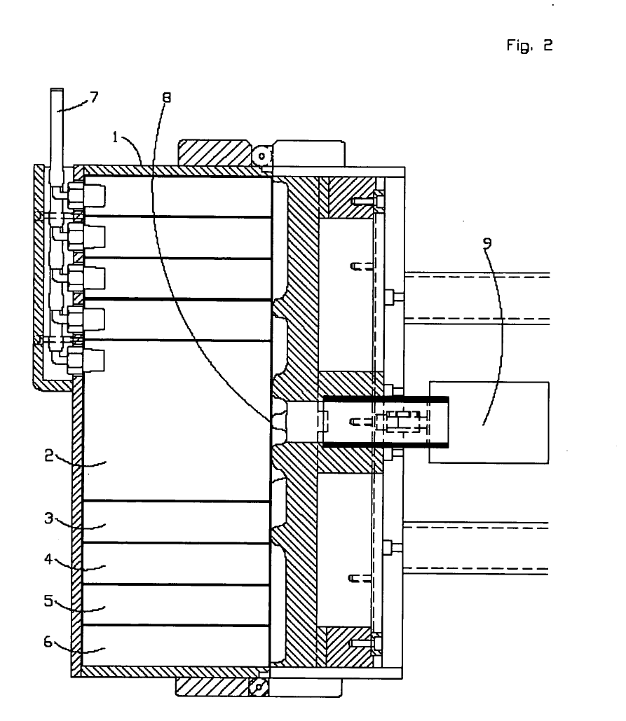

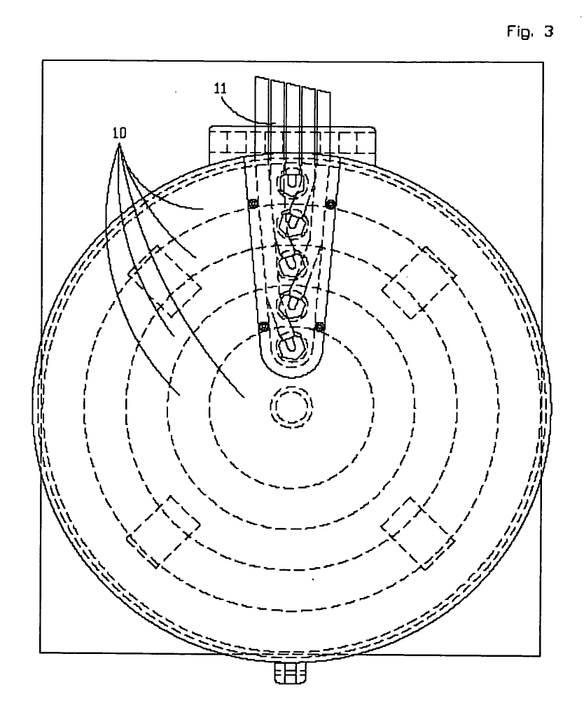

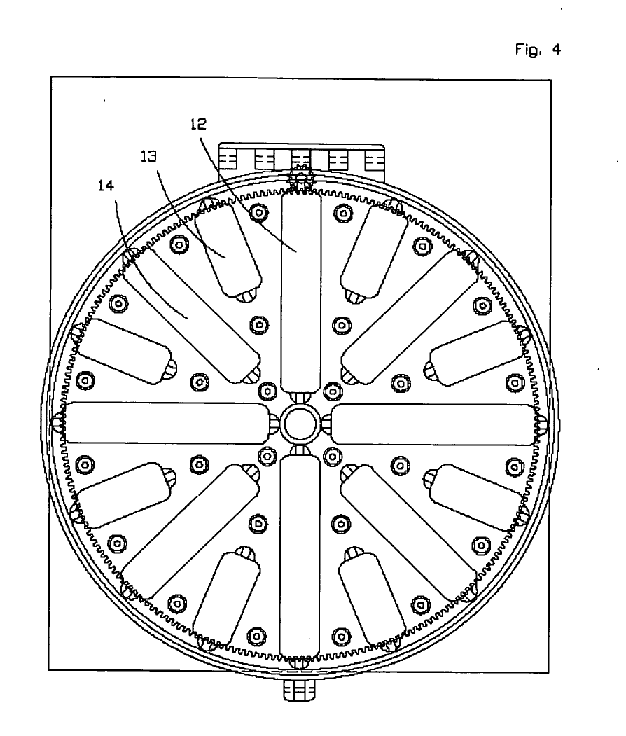

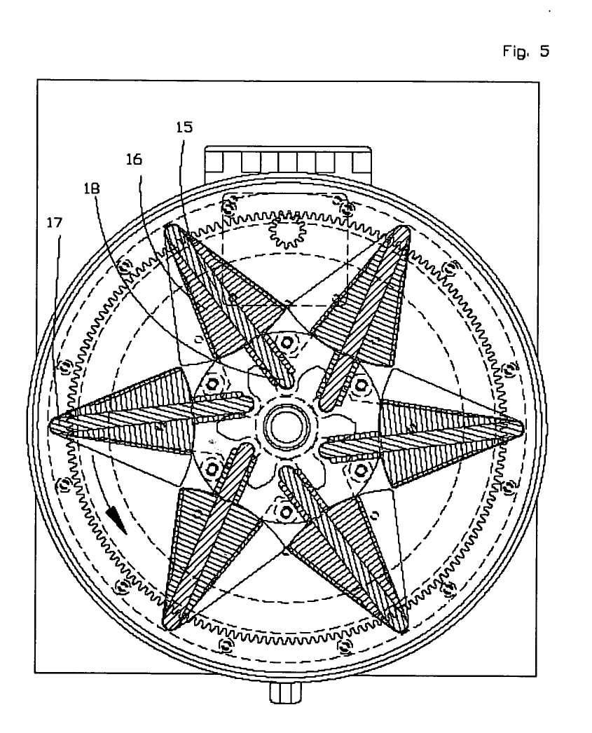

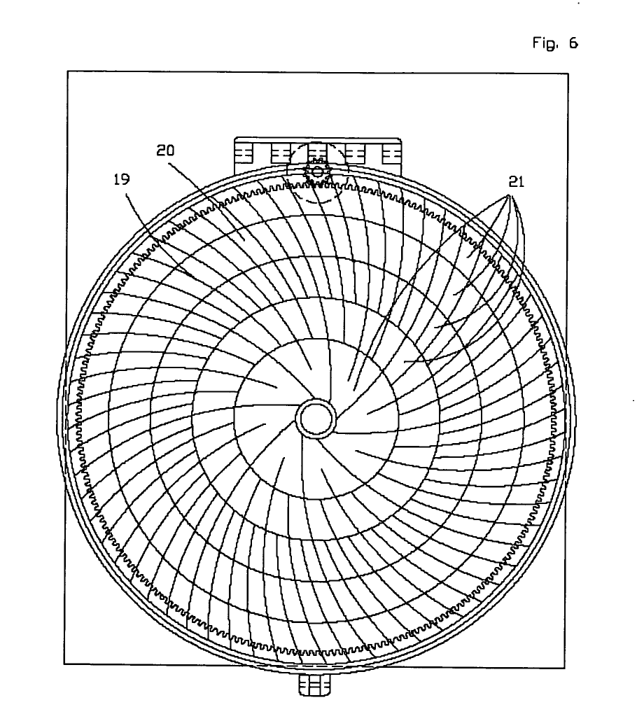

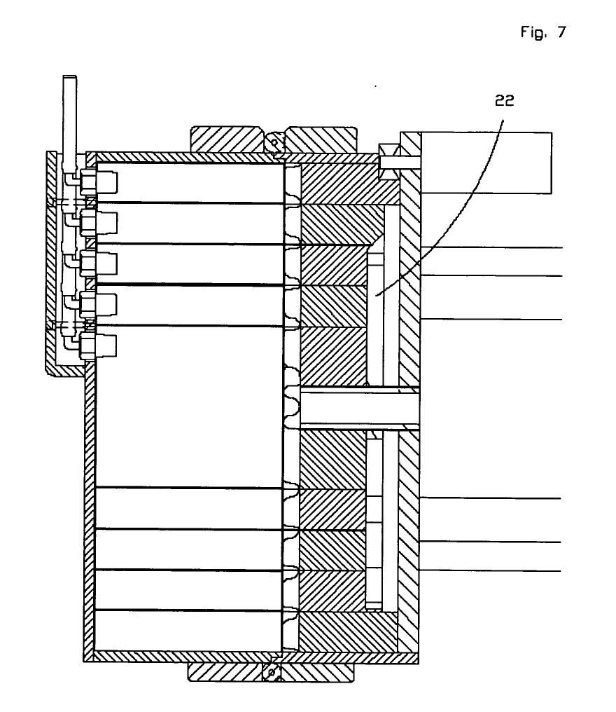

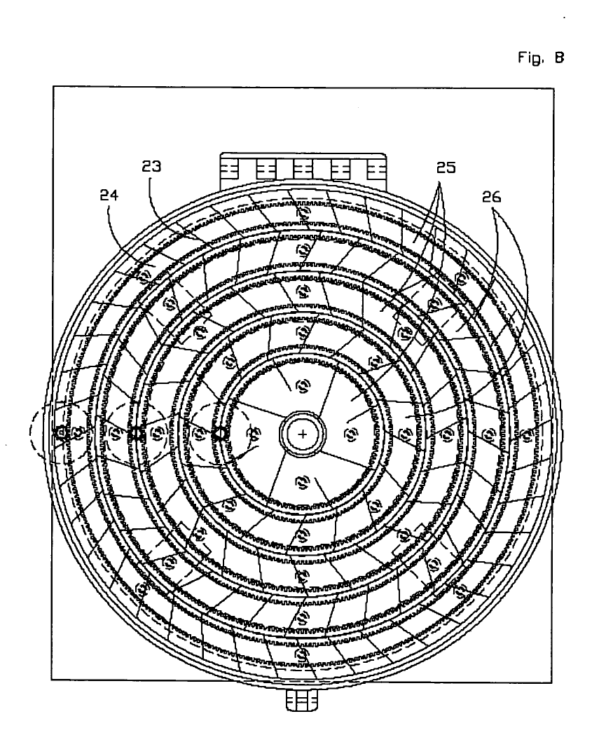

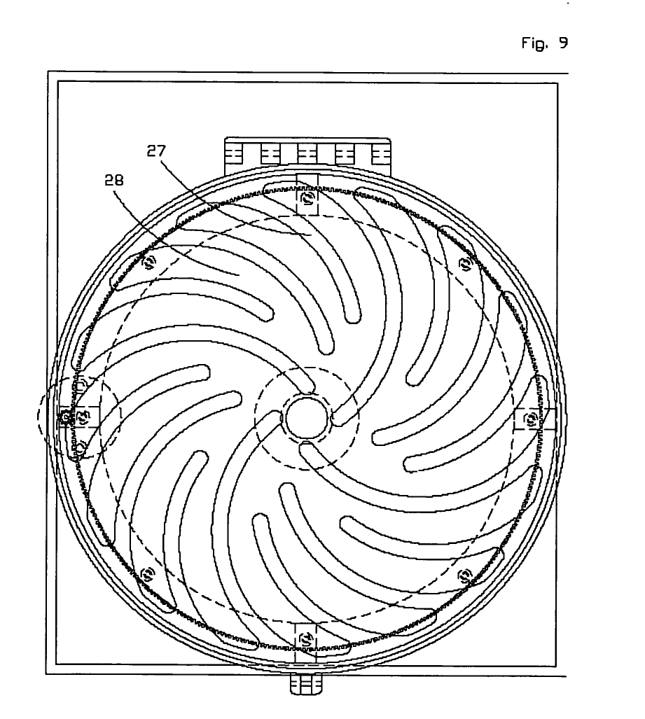

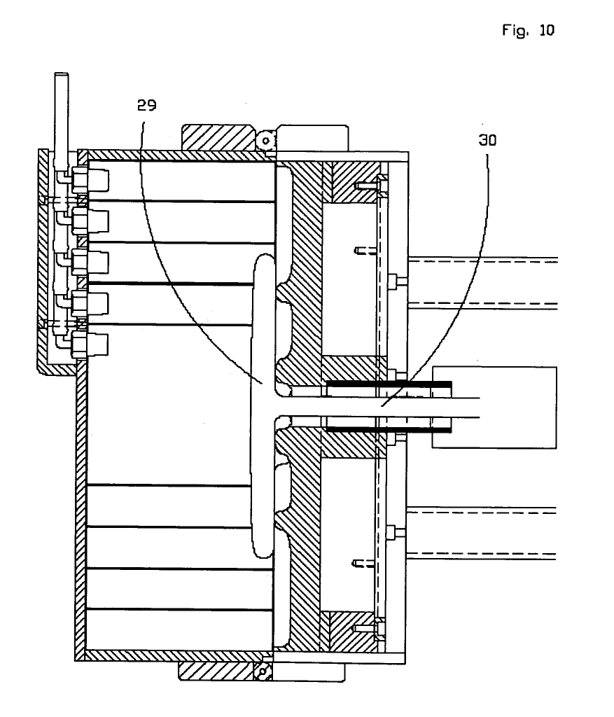

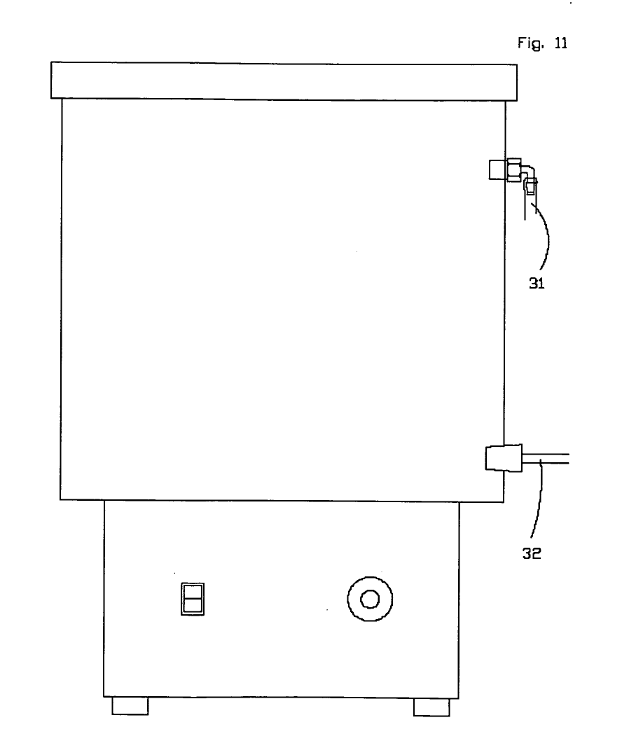

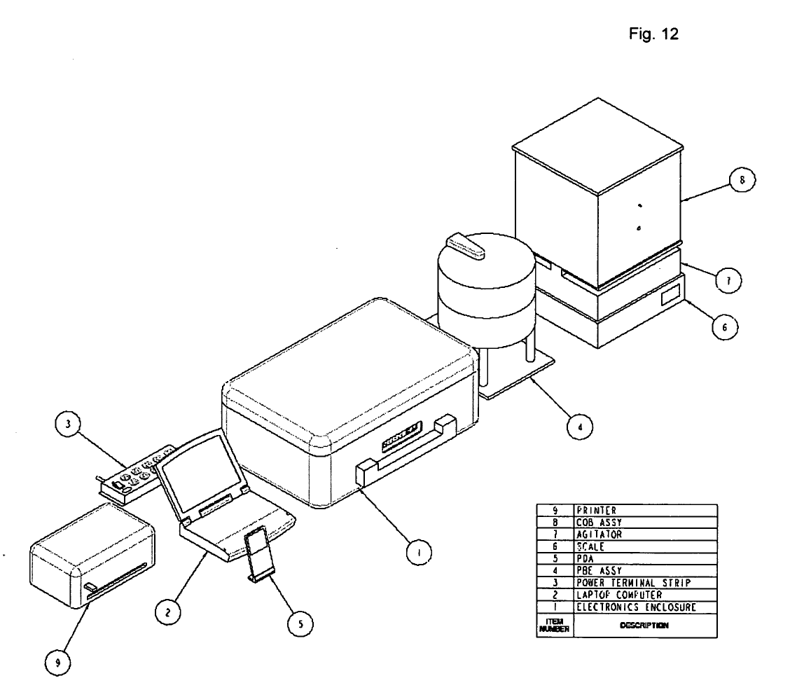

### CROSS-REFERENCE TO PRIOR APPLICATION

This application claims the benefit of U.S. Provisional Application No. 60/859,219 filed Nov. 15, 2006.

### BACKGROUND OF THE INVENTION

The invention relates to a paper coating composition that is especially useful in film press paper coating processes.

For paper coating via blade or film press methods, there is a single layer upper coat weight limit. This limit is defined by 1) the rheology of the coating composition, which composition is referred to in the art as the coating color, and 2) the required minimum pressure to be applied on the metering device in order to guarantee the application of a uniform coat weight over the entire web width; i.e. a flat coat weight application profile in the cross direction. With colors formulated according to the state of the art, typical maximum coat weight limits are 10 grams/m² (gsm) per side for film press coating and 15 gsm/side for blade coating. If the coat weight limit is exceeded, the coat weight application in the cross direction will show significant local defects or fluctuations, resulting in inconsistent product quality.

The practical relevance of this limit is shown by the need to move from single to double coated paper or from double coated to triple coated paper when the desired total coat weight per side is higher than the single coat limit.

In many applications, it is actually of interest to be able to apply as high a coat weight as possible per side in a single pass. For single-layer coated papers, higher coat weights allow replacement of some of the expensive fibers by cheaper coating materials without having to move from a single to a double coating configuration. For double and triple coating, it allows replacement of part of the more expensive topcoat color by cheaper precoat/middle coat color.

It is now state of the art that the precoat in double and triple coated paper is applied to both sides simultaneously using a so-called metering film press, also called a film press. Film press coating has gained wide acceptance because of the many advantages it provides, especially in terms of runnability. However a significant limitation in film press coating is the rather low maximum coat weight per side that can be reliably obtained in a single pass. With colors formulated according to the state of the art, this limit is in the range of 10 gsm/side. Moreover, this limit is lowered as the coating speed decreases. For coating speeds below 600 to 700 m/min; the targeted and desired high coat weights require the use of grooved metering rods instead of smooth ones.

Grooved metering rods have the following issues: 1) they wear out faster than smooth metering rods, and 2) they require changing the coating composition solids or the groove profile in order to maintain the coat weight applied as the rod wears away. For this, respectively, 1) the applied coat weight will steadily decrease with time and 2) color solids need frequent changes and adjustments. As a consequence grooved rods have to be changed regularly, and/or the solids content of colors must be continuously modified, resulting in loss of production time as well as extra spare part cost and/or loss in product quality consistency. Furthermore, grooved rod formulations have well-known rheology-viscosity-solids limitations due to plugging of the grooves and issues relating to making a uniform film on the roll in the application nip.

In film press coating, in order to try to increase the applied coat weight, color formulations and running conditions have to be adapted, which in many cases results in additional drawbacks, such as the following:
a grooved metering rod has to be used instead of a smooth one; resulting in less flexibility in adjusting coat weight, in wearing of the rod and in many cases in streakiness in the coating layer.
the coating speed has to be increased in order to generate enough hydrodynamic counter pressure under the metering element. In combination with the high targeted coat weight, the latter option results in severe misting. In addition, for on-line coaters, hardware limitations can mean that the speed can not be increased, for example due to wet end or drying capacity limitations.
the solids content of the coating color has to be high, which in many cases will result in a runnability issue like bleeding at the metering rod, plugging of the grooves, and streakiness.

Similarly, in order to achieve high coat weight in a single pass in blade coating, the blade loading angle needs to be excessively reduced or the solids content of the coating color has to be increased, which in most cases results in runnability issues such as out of specification cross direction coating profiles or bleeding and streaking.

According to the state of the art, copolymers of acrylamide and acrylic acid are additives used to modify the rheology of the coating color to such an extent that, all other formulation and coating technology parameters being constant, a higher maximum coat weight can be applied. However, in many cases the use of these copolymers as coating color rheology modifiers allows only a minor increase in the maximum coat weight.

It would be desirable to have a coating composition that performs better than those prepared with the existing copolymers of acrylamide and acrylic acid, and that would allow paper coaters to achieve higher single-pass coat weights compared to the state of the art. It would also be desirable to have a film press coating process that provides uniform coating at high coat weight and high speed while exhibiting low misting.

### SUMMARY OF THE INVENTION

A coating composition for paper and/or paperboard comprising:

A) 100 weight parts filler and, per 100 weight parts filler expressed as solids,

B) from 3 to 25 weight parts, expressed as solids, of a binder, and
C) from 0.005 to 2 parts by weight of a water-soluble alkylene oxide polymer having a weight average molecular weight of at least 100,000

wherein the composition has a solids content of at least 65%.

It has been found that when using such a composition, high coat weight can be applied in a single pass, in film press as well as in blade coating, with one or more of the following properties: excellent coat weight cross direction profile control, excellent runnability, and excellent coverage characteristics, typically without compromising any other running parameters.

Surprisingly, paper coating compositions comprising this type of rheology modifier have been found to be far more efficient than acrylamide/acrylic acid copolymers in paper coating processes using blade and film press techniques. For example, in blade coating, it unexpectedly has been found that by addition of a high molecular weight water-soluble polyalkylene oxide to the coating color, the flow of the excess of color that is metered away by the blade actually tends to get laminar, whereas for standard colors that flow is highly turbulent. Avoiding the turbulent flow behind of the blade results in a more constant blade pressure, thereby limiting high frequency blade loading angle variations. As a consequence, “barring” phenomena are significantly reduced.

In another aspect, the invention is a process for preparing coated paper or paperboard, comprising coating a substrate paper or paperboard by a film press process with a paper coating composition comprising:

A) 100 weight parts filler and, per 100 weight parts filler expressed as solids,

B) from 3 to 25 weight parts, expressed as solids, of a binder, and
C) from 0.005 to 2 parts by weight of a water-soluble alkylene oxide polymer having a weight average molecular weight of at least 100,000

wherein the composition has a solids content of at least 65%.

The process of the invention provides unexpectedly improved benefits. For example, the degree of misting, all other factors being equal, is unexpectedly reduced for film press coating when using a coating composition of the invention when compared to coatings formulated without a water-soluble polyalkylene oxide.

### DETAILED DESCRIPTION OF THE INVENTION

The paper coating composition of the invention comprises a binder, a filler, and a water-soluble alkylene oxide polymer having a number average molecular weight of at least 100,000.

For the purposes of the present invention, the term “dry” means in the substantial absence of liquids and the term “dry basis” refers to the weight of a dry material. For example, the solids content of the coating color is expressed as a dry weight, meaning that it is the weight of materials remaining after essentially all volatile materials have been removed.

For the purposes of the present invention, the term “copolymer” means a polymer formed from at least 2 monomers.

As used herein, the term “paper” also encompasses paperboard, unless such a construction is clearly not intended as will be clear from the context in which this term is used.

The binder employed in the coating formulation advantageously comprises a synthetic latex. A synthetic latex, as is well known, is an aqueous dispersion of polymer particles prepared by emulsion polymerization of one or more monomers. For the purposes of the invention, a latex is employed such that the binder has sufficient adhesive properties for use in the manufacture of coated paper. The latex can have a monomodal or polymodal, e.g. bimodal, particle size distribution. Mixtures of binders can be employed.

The binder is employed in an amount sufficient to provide the paper coating with adequate coating strength and adhesion to the substrate. Binders for use in paper coating are well-known and widely commercially available. The binder advantageously is in the form of an aqueous polymeric dispersion. The polymers preferably have a glass transition temperature (Tg) of from −40 to +50° C. The polymer of the binder advantageously is a copolymer, but can be a homopolymer. Examples of typical monomers used to form these polymers are acrylates and methacrylates, acrylonitrile, methacrylonitrile, acrylamide, methacrylamide, ethylenically unsaturated mono-carboxylic and dicarboxylic acids of 3 to 5 carbon atoms, half esters of ethylenically unsaturated dicarboxylic acids of 3 to 5 carbon atoms, vinyl chloride, vinylidene chloride, mono- or polyethylenically unsaturated hydrocarbons, e.g. ethylene, propylene, butylenes, 4-methyl-1-pentene, styrene, butadiene, isoprene and chloroprene, vinyl esters, vinylsulfonic acid, and esters of ethylenically unsaturated carboxylic acids derived from polyhydric alcohols, e.g. hydroxypropyl acrylate and hydroxypropyl methacrylate. Mixtures of monomers can be employed.

In a preferred embodiment of the invention, the binder can contain styrene and/or butadiene and/or acrylonitrile, as well as an ethylenically unsaturated acid in addition to an acrylate. Instead of the acid, other polymerizable hydrophilic compounds can be present as copolymerized units in the copolymers, examples being hydroxyl-containing monomers, e.g. hydroxypropyl acrylate and hydroxypropyl methacrylate. The acrylic esters employed in the polymerization can be derived, for example, from monohydric alcohols of 1 to 12 carbon atoms, preferably from monohydric alcohols of 1 to 4 carbon atoms. The acrylate content in these copolymers can vary within wide limits and can, for example, be from 10 to 99%, or acrylate homopolymers can be used, or acrylate-free polymers can be employed. The content of ethylenically unsaturated acids in these copolymers is as a rule up to 10% by weight. Examples of suitable ethylenically unsaturated acids include acrylic acid, methacrylic acid, vinylsulfonic acid, acrylamidopropanesulfonic acid and itaconic acid. Mixtures of acid monomers can be employed.

The polymethacrylates have a similar structure to that of the polyacrylates, but contain a methacrylate instead of an acrylate. However, it is also possible to copolymerize acrylates and methacrylates with other ethylenically unsaturated compounds for use as the binder. For example, ethylene or propylene can also be used as the comonomer.

Further suitable binders are copolymers comprising butadiene and styrene. These copolymers advantageously contain from 20 to 60% by weight of butadiene and from 40 to 80% by weight of styrene and/or acrylonitrile. They preferably contain additional comonomers, for examples esters of ethylencically unsaturated carboxylic acids of 3 to 5 carbon atoms, with or without up to 10% by weight of other ethylenically unsaturated copolymerizable compounds, e.g. acrylic acid, methacrylic acid, maleic acid, crotonic acid and fumaric acid.

When the binder comprises styrene and butadiene, it is desirable that the latex be carboxylated in order to increase colloidal stability and, hence, the degree of binding efficiency. Examples of suitable carboxylic acid monomers include acrylic acid, methacrylic acid, itaconic acid and fumaric acid. Mixtures of carboxylic acid monomers can be employed in the aforementioned latexes. The amount of carboxylic acid monomer advantageously is from about 1.5 to about 4 weight percent, based on the total weight of monomers employed, preferably is from about 1.8 to about 3%, and more preferably is from about 2 to about 2.4%.

Further polymers that can be used as the binder in the paper coating composition according to the invention are those derived from vinyl esters, e.g. of the type of vinyl acetate or vinyl propionate, or from polymerizable hydrocarbons, e.g. ethylene or propylene, for example copolymers of vinyl esters with acrylates and/or methacrylates and/or acrylonitrile and other compounds that, however, are hydrophilic, e.g. ethylenically unsaturated acids or hydroxyl-containing monomers. The copolymers can also contain yet further ethylenically unsaturated compounds including, for example, acrylamide, N-methylolacrylamide, N-methylolmethacrylamide, vinyl chloride and vinylidene chloride, as copolymerized units. Homopolymers of vinyl esters can also be used.

Binders useful in the practice of the present invention include, for example, styrene-butadiene latex, styrene-acrylate latex, styrene-butadiene-acrylonitrile latex, styrene-maleic anhydride latex, styrene-acrylate-maleic anhydride latex, polysaccharides, proteins, polyvinyl pyrrolidone, polyvinyl alcohol, polyvinyl acetate, cellulose and cellulose derivatives. Examples of preferred binders include carboxylated styrene-butadiene latex, carboxylated styrene-acrylate latex, carboxylated styrene-butadiene-acrylonitrile latex, carboxylated styrene-maleic anhydride latex, carboxylated polysaccharides, proteins, polyvinyl alcohol, and carboxylated polyvinyl acetate latex. Examples of polysaccharides include agar, sodium alginate, and starch, including modified starches such as thermally modified starch, carboxymethylated starch, hydroxyethylated starch, and oxidized starch. Examples of proteins that can be suitably employed in the process of the present invention include albumin, soy protein, and casein.

The water-soluble alkylene oxide polymer that is useful in the composition of the present invention advantageously is a homo- or copolymer having a weight average molecular weight (Mw) of at least 100,000. Examples of the water-soluble alkylene oxide polymer include C₂₋₄ alkylene oxide homo- or copolymers, such as homo- or copolymers of ethylene oxide, propylene oxide, 1,2-butene epoxide and isobutylene oxide. The alkylene oxide polymer preferably comprises an ethylene oxide homo- or copolymer, with poly(ethylene oxide) being the most preferred polymer. Anionic and cationic derivatives of the alkylene oxide polymer can also be employed. Examples of advantageous poly(ethylene oxide) polymers include, for example, various molecular weight polymers available from The Dow Chemical Company as POLYOX WSP brand poly(ethylene oxide)s. Mixtures of alkylene oxide polymers can be employed.

Other useful alkylene oxide polymers are homo- and copolymers of cycloaliphatic epoxides, such as 1,2-cyclohexene epoxide, vinyl cyclohexene oxides, such as 4-vinyl-1-cyclohexene 1,2-epoxide, epoxycyclohexene or 4-vinyl-1-cyclohexene diepoxide; dipentene epoxide, unsaturated glycidyl ethers, such as vinylglycidyl ether or allyl glycidyl ether; alkyl glycidyl ethers, such as methyl glycidyl ether, ethyl glycidyl ether, isopropyl glycidyl ether, isobutyl glycidyl ether, tert-butyl glycidyl ether, n-hexyl glycidyl ether or n-octyl glycidyl ether; 1,3-butadiene diepoxide, styrene oxide, phenyl glycidyl ether or alkyl phenyl glycidyl ethers.

The alkylene oxide copolymers can be random copolymers produced by the polymerization of mixtures of at least two alkylene oxides. Other useful alkylene oxide copolymers are block copolymers produced by the sequential addition of more than one alkylene oxide, in which nearly total consumption of each alkylene oxide takes place prior to the addition of subsequent monomer(s). Alternatively, the alkylene oxide copolymer can comprise in copolymerized form an alkylene oxide and another copolymerizable monomer, such as methyl acrylate, ethyl acrylate, a caprolactone, ethylene carbonate, trimethylene carbonate, 1,3-dioxolane, carbon dioxide, carbonyl sulfide, tetrahydrofuran, methyl isocyanate, or methyl isocyanide. Preferred alkylene oxide copolymers are copolymers of ethylene oxide with epichlorohydrin or copolymers of ethylene oxide with cyclohexene oxide. Alkylene oxide copolymers generally comprise at least 50 mole percent, preferably at least 70 mole percent, more preferably at least 85 mole percent alkylene oxide units. The most preferred alkylene oxide polymers are ethylene oxide copolymers or, more preferably, ethylene oxide homopolymers.

The water-soluble alkylene oxide polymer advantageously has a water-solubility of at least 5 grams, preferably at least 10 grams, in 100 grams of distilled water at 25° C. at 1 atmosphere. The water-soluble alkylene oxide polymer advantageously has a weight average molecular weight of from 100,000 to 8,000,000, preferably from 400,000 to 5,000,000, more preferably from 600,000 to 2,000,000, and most preferably from about 800,000 to about 1,000,000. In various embodiments of the invention, the weight average molecular weight of the water-soluble alkylene oxide polymer is at least 100,000, at least 400,000, at least 600,000 or at least 800,000. In various embodiments of the invention, the weight average molecular weight of the water-soluble alkylene oxide polymer is at most 8,000,000, at most 5,000,000, at most 2,000,000 or at most 1,000,000. Water-soluble alkylene oxide polymer molecular weights are determined by gel permeation chromatography.

Pigments used in paper coating are well known and widely commercially available. Examples of pigments include clay, kaolin, talc, calcium carbonate, titanium dioxide, calcium aluminum pigments, satin white, synthetic polymer pigments, zinc oxide, barium sulphate, gypsum, silica, alumina trihydrate, mica, and diatomaceous earth. Kaolin, talc, calcium carbonate, titanium dioxide, satin white and synthetic polymer pigments, including hollow polymer pigments, are particularly preferred. Mixtures of pigments can be employed.

If desired, conventional additives can be incorporated into the compositions of the invention in order to modify the properties thereof. Examples of these additives include conventional thickeners, dispersants, dyes and/or colorants, biocides, anti-foaming agents, optical brighteners, wet strength agents, lubricants, water retention agents, crosslinking agents, surfactants, and the like.

To produce a paper coating composition of the invention, the binder, filler and water-soluble alkylene oxide polymer can be mixed by conventional methods. The sequence in which the individual components of the paper coating composition are mixed is not critical, but it is advantageous to add the water soluble polymer at the end of the preparation of the coating composition. The water-soluble alkylene oxide polymer can be added as a powder or as a solution, but preferably is added as an aqueous solution, as the direct addition as a powder often results in the formation of agglomerates that can be difficult to dissolve.

The paper coating composition of the invention advantageously comprises, per 100 parts by weight of pigment, from about 3 to about 25 parts by weight of binder, and from about 0.005 to about 2 parts by weight of the water-soluble alkylene oxide polymer. Preferably, the binder is employed in an amount of from about 4 to about 16 parts. In various embodiments of the invention, the paper coating composition comprises at least 3, preferably at least 4, parts by weight binder. In various embodiments of the invention, the paper coating composition comprises at most 25, preferably at most 16, parts by weight binder. Preferably, the water-soluble alkylene oxide polymer is employed in an amount of from about 0.01 to about 0.5 parts, and more preferably from about 0.02 to about 0.2 parts. In various embodiments of the invention, the paper coating composition comprises at least 0.01, preferably at least 0.02, parts by weight water-soluble alkylene oxide polymer. In various embodiments of the invention, the paper coating composition comprises at most 0.5, preferably at most 0.2, parts by weight binder.

The rheology of the coating composition can vary widely as is known in the art, depending on the result desired, and the solids content of the coating composition can be any solids content that is runnable on a film press coater. The paper coating composition solids content advantageously is at least 50 percent, preferably is at least about 65%, more preferably is at least about 67%, and more preferably is at least about 69%. The paper coating composition solids content advantageously is at most 77 percent, preferably is at most about 75%, more preferably is at most about 73%, and more preferably is at most about 72%. In one embodiment of the invention, the solids content is from 60 to 75 percent, while in another embodiment the solids content is from 69 to 80 percent, preferably from 69 to 72 percent. The paper coating composition advantageously has a viscosity of up to about 5,000 cP (centipoise), and more preferably is from about 200 to about 2,000 cP.

The composition of the invention is especially useful in paper coating via the blade coating process and/or the film press coating process. These processes are well known in the art. The color composition of the invention advantageously is designed to apply per single pass a coat weight in the range of about 3 to about 30 gsm per side. Advantageously, a coat weight of at least 10 gsm is applied to at least one side of the substrate paper in a single pass by the film press process. In one embodiment of the invention, a coat weight of at least 15 gsm is applied to at least one side of the substrate paper in a single pass by the blade coating process. A pronounced advantage of one embodiment of the present invention is that the applied coat weight on the paper per single pass can be from more than 10 to about 20 gsm per side for film press coating and from about 15 to about 30 gsm for blade coating. These preferred coat weight values are higher than those obtainable with conventional and state of the art paper film press coating compositions. Advantageously, the average coat weight applied by the film press process of the invention is at least 24 gsm, preferably is at least 26 gsm, and more preferably is at least 28 gsm.

The web substrate velocity of the process of the invention can vary widely. Advantageously the substrate velocity is at least 800 m/min., preferably is at least 1000 m/min., more preferably is at least 1200 m/min., even more preferably at least 1300 m/min., and more preferably at least 1400 m/min. Advantageously the substrate velocity is limited on the high end only by the limitations of the equipment employed. In one embodiment of the invention, the substrate velocity is at most 2200 m/min.

As is understood by those skilled in the art, a film press coater utilizes one or more applicators to transfer coating composition, or color, to the outer surfaces of one more rolls, which in turn transfers the coating from the roll surface to one or more sides of the web for coating paper.

In film press coating, misting is an issue when high coat weights are applied at high speed. Surprisingly, it has been found that by using the water-soluble alkylene oxide polymer according to the invention, misting can be significantly reduced even at high coat weight. According to one embodiment of the invention, coating colors according to the invention allow film press coating with a combination of high coat weight and high speed without misting. Industry practice today means that to avoid misting, high coat weights have to be run in conjunction with low speed. Conversely, current practice means that for a film press to run at high speed, only low coatweights can be employed.

For the purposes of the invention, the term “degree of misting” means the collected mass of misted coating composition in grams per meter of paper web width per second. Advantageously, the degree of misting is less than 0.050 g/m-sec, and preferably is less than 0.025 g/m-sec, more preferably less than 0.010 g/m-sec and most preferably is less than 0.005 g/m-sec. For the purposes of the invention, the term “percent loss to misting” means the amount of coating composition lost to misting as a weight percentage of the amount of coating composition applied. Advantageously, the percent loss to misting is less than 0.02%, preferably is less than 0.1%, and more preferably is less than 0.05%.

For the purposes of the invention, the term “Profile Index” represents the degree of coating uniformity and is calculated as shown following Table 6. Advantageously, the coating composition of the invention allows film press coating such that the Profile Index is not greater than 0.11, not greater than 0.10, not greater than 0.09, not greater than 0.08, not greater than 0.07 or not greater than 0.06.

For the purposes of the invention, it is to be understood, consistent with what one of ordinary skill in the art would understand, that a numerical range is intended to include and support all possible subranges that are included in that range. For example, the range from about 1 to about 100 is intended to convey from about 1.01 to about 100, from about 1 to about 99.99, from about 1.01 to about 99.99, from about 40 to about 60, from about 1 to about 55, etc.

### Specific Embodiments of the Invention

The following examples are given to illustrate the invention and should not be construed as limiting in scope. All parts and percentages are by weight unless otherwise indicated.

Test Methods

Brookfield Viscosity

The viscosity is measured using a BROOKFIELD RVT viscometer (available from Brookfield Engineering Laboratories, Inc., Stoughton, Mass., USA). The viscosity is measured at 25° C. at a spindle speed of 100 rpm, unless otherwise specified.

Paper Gloss

Paper gloss is measured using a ZEHNTNER ZLR-1050 instrument at an incident angle of 75°.

Paper Roughness

The roughness of the coated paper surface is measured with a Parker PrintSurf roughness tester. A sample sheet of coated paper is clamped between a cork-melinex platen and a measuring head at a clamping pressure of 1,000 kPa. Compressed air is supplied to the instrument at 400 kPa and the leakage of air between the measuring head and the coated paper surface is measured. A higher number indicates a higher degree of roughness of the coated paper surface.

Ink Gloss

The test is carried out on a Pruefbau Test Printing unit with Lorrilleux Red Ink No. 8588. An amount of 0.8 g/m² (or 1.6 g/m² respectively) of ink is applied to coated paper test strips mounted on a long rubber-backed platen with a steel printing disk. The pressure of the ink application is 1,000 N and the speed is 1 m/s. The printed strips are dried for 12 hours at 20° C. at 55% minimum room humidity. The gloss is then measured on a ZEHNTNER ZLR-1050 instrument at an incident angle of 75°.

Dry Pick Resistance (IGT)

This test measures the ability of the paper surface to accept the transfer of ink without picking. The test is carried out on an A2 type printability tester, commercially available from IGT Reprotest BV. Coated paper strips (4 mm×22 mm) are printed with inked aluminum disks at a printing pressure of 36 N with the pendulum drive system and the high viscosity test oil (red) from Reprotest BV. After the printing is completed, the distance where the coating begins to show picking is marked under a stereomicroscope. The marked distance is then transferred into the IGT velocity curve and the velocities in cm/s are read from the corresponding drive curve. High velocities mean high resistance to dry pick.

Wet Pick

The test is carried out on a Pruefbau Test Printing unit equipped with a wetting chamber. 500 mm³ of printing ink (Hueber 1, 2, 3 or 4, depending on overall wet pick resistance of the paper) is distributed for 2 min on the distributor; after each print re-inking with 60 mm³ of ink. A vulcanized rubber printing disk is inked by being placed on the distributor for 15 sec. Then, 10 mm³ of distilled water is applied in the wetting chamber and distributed over a rubber roll. A coated paper strip is mounted on a rubber-backed platen and is printed with a printing pressure of 600N and a printing speed of 1 m/s. A central strip of coated paper is wetted with a test stripe of water as it passes through the wetting chamber. Printing is done on the same test strip immediately after coming out of the wetting chamber. Off print of the printing disk is done on a coated paper test strip fixed on a rubber-backed platen; the printing pressure is 400N. Ink densities on both test strips are measured and used in the following formulas:

Ink transfer, defined as X=(B/A)*100%

Ink refusal, defined as Y=((100*D−X*C)/100*A)*100%, and

Wet pick, defined as Z=100−X−Y %; where

A is the ink density on non-wetted side stripes of the first coated test strip,

B: is the ink density on wetted central stripe of the first coated test strip,

C: is the ink density on side stripes for the off print on the second coated strip, and

D: is the ink density on central stripe for the off print on the second coated strip.

Ink Piling

Ink piling is tested on a Pruefbau printability tester. Paper strips are printed with ink commercially available under the trade name Huber Wegschlagfarbe No. 520068. A starting amount of 500 mm³ is applied to an ink distribution roll. A steel printing disk is inked to achieve an ink volume of 60 mm³. A coated paper strip is mounted on a rubber-backed platen and printed with the inked steel disk at a speed of 1.5 n/s and a printing pressure of 800 N. After a 10 second delay time, the paper strip is re-printed using a vulcanized rubber printing disk also containing 60 mm³ of ink and at a printing pressure of 800N. This procedure is repeated until the surface of the coated paper strip ruptures. The number of printing passes required to rupture the coated paper surface is a measure of the surface strength of the paper.

Ink Mottling

This test is done to assess the degree of print irregularity. Paper strips are printed on the Pruefbau Test Printing unit with test ink commercially available under the trade designation Huber Wegschlagfarbe NO. 520068. First, 250 mm³ of ink is applied with a steel roll. Then, three passes using a dry vulcanized rubber roll follow, to remove the wet layer. For evaluation of mottling, the strip is digitally analyzed using the Mottling Viewer Software from Only Solutions GmbH. First, the strip is scanned and the scan is converted to a gray scale. Then the deviation in gray scale intensity is measured at seven different resolutions with a width of 0.17 mm, 0.34 mm, 0.67 mm, 1.34 mm, 2.54 mm, 5.1 mm and 10.2 mm. From these measurements a mottle value (MV) is calculated. The result shows the degree of print irregularity. A higher number indicates a higher irregularity.

Coat Weight

The coat weight is measured by an on-line device comprising a beta ray Krypton 85 radioactive source and detector (available from Measurex). The amount of radiation passing through the sheet is proportional to the sheet basis weight. The transmission of beta rays is measured before and after coating to allow the coat weight to be determined by difference. The response of the coat weight measuring device is calibrated in a pre-trial for each base paper/mineral pigment system combination by comparing the coat weight read-out to bone dry coat weights. Bone dry coat weights are determined by calculating the weight difference of base paper and coated paper after drying in an oven at 110° C. for 30 minutes. Using this method, when coating is applied to two sides of a paper simultaneously, only total coat weight can be determined.

Coat weight profiles are obtainable due to the fact that the radioactive source and the detector scan across the cross direction of the paper during the coating run.

Materials

The following materials are used in the preparation of coating compositions:
Carbonate (A): dispersion of calcium carbonate with particle size of 60%<2 μm in water (HYDROCARB® 60 available from Pluess-Stauffer, Oftringen, Switzerland), 78% solids.
Carbonate (B): dispersion of calcium carbonate with particle size of 90%<2 μm in water (HYDROCARB® 90 available from Pluess-Stauffer), 78% solids.
Clay (A): dispersion of high brightness clay with particle size of 90%<2 μm in water (ULTRAWHITE from Engelhard, USA), 71% solids.
Clay (B): dispersion of high brightness Brazilian clay in water (CAPIM SP available from Imerys, St. Austell, England), 68% solids.
Latex (A): carboxylated styrene-butadiene latex (XZ 94362 available from The Dow Chemical Company, Midland, Mich., USA), 50% solids in water.
Latex (B): carboxylated styrene-butadiene latex (DL 966 available from The Dow Chemical Company, Midland, Mich., USA), 50% solids in water.
Latex (C): carboxylated styrene-butadiene latex (XZ 96467.00 available from The Dow Chemical Company, Midland, Mich., USA), 50% solids in water
Starch: thermally hydrolyzed modified corn starch, Bookfield Viscosity (100 rpm) of 25% solution at 40° C.=185 mPa·s (C-FILM 07311 available from Cerestar, Krefeld, Germany).
PVOH: low molecular weight synthetic polyvinyl alcohol (MOWIOL® 6/98 available from Kuraray Specialties Europe, Frankfurt, Germany), prepared as a solution of 23% solids.
CARBOWAX PEG400: polyethylene glycol (available from The Dow Chemical Company, Midland USA), 100% concentration.
CMC: low molecular weight carboxy methyl cellulose (FF10 available from, CPKelco, Aanekoski, Finland).
STEROCOLL BL: an inverted dispersion of water in oil of an acrylamide acrylic acid copolymer, with a solids content of 35% and available form BASF, Germany.
POLYOX WSR of different grades; poly(ethylene oxide) of various molecular weight (POLYOX WSR N-10 of approximate molecular weight 100,000; POLYOX WSR N-80 of approximate molecular weight 200,000; POLYOX WSR N-3000 of approximate molecular weight 400,000; POLYOX WSR-205 of approximate molecular weight 600,000; POLYOX WSR-1105 of approximate molecular weight 900,000; available from The Dow Chemical Company, Midland, Mich., USA). For these examples, POLYOX WSR is employed as a 4% active aqueous solution prepared according to following procedure: 1) a slurry of POLYOX WSR and CARBOWAX PEG400 is prepared by addition with agitation of 1 part POLYOX WSR powder to 2 parts of CARBOWAX PEG400; 2) the resulting mixture is added to water in order to obtain a 4% POLYOX WSR solution, based on the weight of the solution.
OBA: fluorescent whitening agent derived from diamino-stilbenedisulfonic acid (TINOPAL® ABP/Z, available from Ciba Specialty Chemicals Inc. Basel, Switzerland).
Base Paper A: wood free, 58 gsm
Base Paper B: wood containing, 42 gsm
Base Paper C: wood free precoated, with base paper grammage of 75 gsm and a coat weight of 10 gsm per side applied with flooded nip and stiff blade.

Coating Preparation Method

The above ingredients are mixed in the amounts as given in the compositions tables relevant for the various examples. The pH of the pigmented coatings formulations is adjusted to 8.5 by adding a NaOH solution (10%). Water is added as needed to adjust the solids content of the formulations.

Operating Conditions

The formulations are coated onto paper according to the following procedure, referring to premetering film press and blade application methods.

For film press coatings, a premetering film press device is employed such that the color, by a feeding chamber, is applied and immediately metered on an applicator roll and is then transferred through a nip on the corresponding side of the paper. The feeding chamber is a full width chamber fed on one side, and is specifically designed to provide a uniform and stable flow distribution in the cross direction. The term “cross direction” means the direction in the plane of the substrate paper, or parallel to the plane of the substrate paper, and perpendicular to the direction of movement of the substrate paper.

The applicator rolls are stainless steel polished rolls with a polyurethane coating of 33-38+/−5 P&J hardness. The total roll diameter is 1200 mm. The metering device is a smooth rod, with one side driven by an electrical motor. Rod diameters are 15, 25, or 35 mm. The rod is installed in a rod holder. Rod holders are polyurethane or polyethylene. The rods are pressed pneumatically onto the applicator rolls to determine and modify the color thickness. Rod pressures are in the range of 80 up to 300 kPa. Trials are run at coating speeds of from 1000 to 1500 m/min. The applicator rolls are hydraulically loaded. The nip pressures are from 15 to 30 kN/m, adjusted to avoid paper instability and wrinkles on the coater. The uniformity of the applied coat weight is measured by the profiles of the total application, and is recorded continuously by an online quality scanner control system. The trials are run at various targeted coat weights, varying the pressure of the rod. Corresponding coating profiles are measured and recorded. Other trials are run at fixed rod pressures. Profiles and average coat weight for each rod pressure are measured and recorded.

For blade coating, the color is applied in excess to a running web and then is metered with a blade. The application system can be an applicator roll, flooded in a color pan or can be a free jet. However, for these runs a free jet is employed, with a dearation system on the feeding line. The impingement angle of the jet and the nozzle opening are maintained constant for all runs at, respectively, 50° and 0.85 mm. The metering element is a stiff blade in conventional blue steel. Blade dimensions are 76 mm×16 mm high×0.4 mm thick. The coating head angle is between 35 and 45°. The blade pressure is changed during the trials changing the blade loading angle from 8° up to 24°. Note that the term “blade angle” refers to the angle of the blade at or near the substrate, whereas the term “blade loading angle” refers to the angle of the blade at the clamp. Trials are run at coating speeds of from 800 to 1400 m/min. The uniformity of the applied coat weight is measured by the profiles of the application. Some of the trials are run at various targeted coat weights, varying the blade loading angle. Corresponding coating profiles are registered. Other trials are run at a fixed loading angle. Average profiles and coat weight for each blade loading angle are recorded.

As defined by hardware suppliers: the term “coating head angle” refers to the working angle of the coating head. The coating head angle is equal to the beveled angle of the tip of the blade at or near the substrate and so is also called blade angle. The “blade loading angle” is a measure of the pressure the blade is generating onto the paper: lower blade loading angle means lower pressure (and so higher coat weight), higher blade loading angle means higher pressure (and so lower coat weight).

Details on coating color compositions, base paper and coater device running conditions and settings are given in each of the examples.

### Example 1

### Film Press Coating; Increase of Average Coat Weight and Improvement of Cross Direction Profile

Example 1 illustrates the positive impact of the composition of the invention on the control of the cross direction profile in film press coating, in the case of a high coat weight. The target of the trial is to apply via film press a precoat of total coat weight (both sides) of 25 gsm at a coating speed below 1300 m/min, ideally below 1000 m/min. A 25 mm diameter smooth rod and Base Paper A are used.

For Example 1, for a fixed coating speed, the metering rod pressure is adjusted in order to try to reach a targeted average total coat weight of 25 gsm. By reducing rod pressure, the average coat weight increases but also cross direction profile deteriorates. If the cross direction profile becomes unacceptable, the rod pressure is not further decreased, even if the average total coat weight is below target.

The results of the following Examples 1-1 and 1-2, and Comparative Experiments 1-A and 1-B are summarized in Table 1.

### Comparative Experiment 1-A

### Not an Embodiment of the Invention

Color F4, which does not contain any specific component designed for allowing higher coat weights, is the control. FF10, a low molecular weight CMC is used in order to adjust the shear viscosity of the color. In order to be able to reach an average coat weight of 25 gsm, the coating speed must be increased to 1500 m/min, which is above the target speed. Rod pressure must be decreased to 0.8 bar.

The resulting cross direction profile is very bad, with maximal and minimal coat weights of respectively 29.3 and 19 gsm, i.e. 10 gsm difference between the extreme coat weight values. The cross direction profile has a parabolic shape, with much more color in the middle than at the edges. The bad cross direction profile is related to the rod pressure, which is too low to ensure a homogeneous and constant rod control across the web width. A higher “average” coat weight could be reached by using lower rod pressure, but the profile would be even worse. For this color, in order to keep a good cross direction profile for a coating speed of 1500 m/min., the average coat weight cannot exceed 20 gsm total.

### Comparative Experiment 1-B

### Not an Embodiment of the Invention

Coating Color F1 is a reference color for targeting high coat weights and is formulated according to the state of the art, in that it contains 0.03 parts (dry/dry) of STEROCOLL BL.

At 1300 m/min, the cross direction profile remains acceptable for an average coat weight of 21.8 gsm; i.e. about 3 gsm below the targeted value. Coat weight difference between the extremes is about 3 gsm. For this speed and average coat weight, the rod pressure is 1.5 bar. At 1300 m/min, reducing the rod pressure to 0.6 bar increases the average coat weight to 23.2 gsm, but profiles become unacceptable.

### Example 1-1

Color F2 contains 0.05 parts of POLYOX WSR 1105. At 1300 m/min, an excellent cross direction profile is obtained even for 26 gsm average coat weight. The coat weight difference between the extremes is only 1.5 gsm. The profile is also much better, i.e. more uniform in the cross direction, than the 23.2 gsm total coat weight profile for color F1.

The rod pressure is 3 bars. This surprisingly high value results from the rheology properties of the color when using POLYOX WSR 1105, and allows a constant and stable rod control across the web width.

### Example 1-2

Color F3 contains 0.03 parts of POLYOX WSR 1105. At 1300 m/min and rod pressure 1.7 bar, an average coat weight of 25 gsm is reached with a good cross direction profile; the coat weight difference between extremes being 3 gsm. The profile is also much better than the 23.2 gsm total coat weight profile for color F1.

At 1000 m/min and a rod pressure of 0.8 bar, the average coat weight is 25.2, with a good profile; the coat weight difference between extremes being 4 gsm. A further advantage of color F3 is that at the reduced speed it allows reaching the target coat weight and also generates less misting at the nip exit. At 1000 n/min there is almost no misting.

TABLE 1

| | | F1* | F2 | F3 | F4* |
|---|---|---|---|---|---|
| CARBONATE (A) | | 100 | 100 | 100 | 100 |
| LATEX A | | 11 | 11 | 11 | |
| LATEX (B) | | | | | 11 |
| CMC | | 0.3 | 0.3 | 0.3 | 0.3 |
| OBA | | 0.8 | 0.8 | | 0.8 |
| STEROCOLL BL (acrylamide | | 0.035 | | | |
| acrylic acid copolymer) | | | | | |
| POLYOX WSR 1105 | | 0 | 0.05 | 0.03 | |
| Coating solids (%) | | 69 | 69.2 | 70.0 | 70 |
| Viscosity (centipoise) | | 710 | 910 | 890 | 890 |
| 1500 m/min | Total Coat | Trial | Trial | Trial | 25.3 |
| | weight average | not run | not run | not run | |
| | on both sides | | | | |
| | CW max (gsm) | | | | 29.35 |
| | CW min (gsm) | | | | 19.18 |
| | Rod pressure | | | | 0.8 bar |
| 1300 m/min | Total Coat | 21.8 | Trial | Trial | Trial |
| | weight average | | not run | not run | not run |
| | on both side | | | | |
| | CW max (gsm) | 22.8 | | | |
| | CW min (gsm) | 19.95 | | | |
| | Rod pressure | 1.5 bar | | | |
| 1300 m/min | Total Coat | 23.2 | 26.2 | 25.1 | Trial |
| | weight average | | | | not run |
| | on both side | | | | |
| | CW max (gsm) | 24.95 | 26.96 | 27.71 | |
| | CW min (gsm) | 19.35 | 25.52 | 24.6 | |
| | Rod pressure | 0.6 bar | 3.0 bar | 1.7 bar | |
| 1000 m/min | Total Coat | Trial | Trial | 25.2 | Trial |
| | weight average | not run | not run | | not run |
| | on both side | | | | |
| | CW max (gsm) | | | 26.8 | |
| | CW min (gsm) | | | 22.8 | |
| | Rod pressure | | | 0.8 bar | |

*Not an embodiment of the invention.

As shown by Example 1, the poly(ethylene oxide) modifies the rheology properties of the color, allowing a significant increase of the hydrodynamic pressure of the rod. The rod pressure needs to be increased in order to meter the targeted coat weight. The increased hydrodynamic pressure that is applied by the color on the rod helps to keep more uniform rod control across the paper web width, resulting in improved cross direction profiles.

By using poly(ethylene oxide) the targeted coat weight of 25 gsm total could even be reached at a speed as low as 1000 n/min, whereas for color F1 formulated according to state of the art, the coating speed had to be at least 1300 m/min and for color F4 the speed needs to be above 1500 n/min. This demonstrates that the invention can be used on existing on-line coating equipment.

By using POLYOX WSR 1105, which surprisingly allows the use of the reduced speed of 1000 m/min, it is possible to run without misting. With reference color F1 or F4, because of the high speed needed to get the targeted coat weight, misting is very pronounced.

### Example 2

### Film Press Coating; Increase of Rod Pressure Imparted by POLYOX WSR 1105

Example 2 more specifically illustrates this impact of poly(ethylene oxide) on rod pressure. Coating Colors F6-F9 are similar to Color F5 except that they contain varying amounts of POLYOX WSR 1105. The results of Example 2 are given in Table 2.

TABLE 2

| | | F5* | | F6 | | F7 | | F8 | | F9 | |
|---|---|---|---|---|---|---|---|---|---|---|---|
| CARBONATE (A) | | 100 | | | | | | | | | |
| LATEX (B) | | 8.5 | | | | | | | | | |
| STARCH | | 5 | | | | | | | | | |
| OBA | | 0.07 | | | | | | | | | |
| POLYOX WSR 1105 | | 0 | | 0.005 | | 0.01 | | 0.02 | | 0.04 | |
| Coating solids (%) | | 69.1 | | 68.9 | | 69 | | 68.8 | | 69 | |
| Viscosity (cP) | | 420 | | 480 | | 560 | | 580 | | 440 | |
| 1300 m/min | Rod diameter | 35 | mm | 35 | mm | 35 | mm | 15 | mm | 15 | mm |
| 10 gsm | Rod pressure | 1.2 | bar | 1.50 | bar | 2.99 | bar | 1.40 | bar | 2.70 | bar |
| 1500 m/min | Rod diameter | 35 | mm | trial | | 15 | mm | 15 | mm | trial | |
| 8.5 gsm | Rod pressure | 3 | bars | not run | | 0.75 | bar | 3.00 | bar | not run | |
| 1500 m/min | Rod diameter | 35 | mm | 35 | mm | 25 | mm | 15 | mm | 15 | mm |
| 10 gsm | Rod pressure | 1.98 | bar | 2.80 | bar | 2.10 | bar | 1.59 | bar | 2.99 | bar |
| 1500 m/min | Rod diameter | 35 | mm | 35 | mm | 35 | mm | 15 | mm | 15 | mm |
| 12 gsm | Rod pressure | 1.2 | bar | 1.40 | bar | 2.20 | bar | 1.00 | bar | 2.00 | bar |

*Not an embodiment of the invention.

Example 2 focuses on the impact of POLYOX WSR 1105 on the rod pressure, without considering the cross direction profiles. In this example the paper is only coated on one side with the film press. Rod pressures are adjusted in order to reach the given target coat weights at specified coating speeds. If at maximum rod pressure the actual coat weight is above target, metering rods of lower diameter are used.

In all of these trials, the addition of POLYOX WSR 1105 allows a significant increase of the road pressure. In many cases, the increase of hydrodynamic pressure on the rod is so high that a rod of smaller diameter must be used compared to the rod used for color F5. The higher the POLYOX WSR 1105 content, the higher the rod pressure. A significant effect on rod pressure is seen even at 0.01 parts POLYOX WSR 1105.

### Example 3

### Film Press Coating; Impact of POLYOX on Coating Color Film Uniformity on Transfer Roll

In Example 3 the impact of POLYOX WSR 1105 on the uniformity of the coating color film metered on the transfer roll is checked. The metering rod pressure is adjusted in order to reach coat weight. The uniformity of distribution of the wet coating color film on the transfer roll is assessed visually.

TABLE 3

| | |
|---|---|
| F10* | F11 |

| CARBONATE (A) | | 100 | | 100 | |
|---|---|---|---|---|---|
| LATEX (C) | | 11 | | 11 | |
| OBA | | 0.07 | | 0.07 | |
| POLYOX WSR 1105 | | | | 0.07 | |
| Coating solids (%) | | 72 | | 69.5 | |
| Viscosity (cP) | | 210 | | 120 | |
| 1300 m/min | Rod diameter | 25 | mm | 15 | mm |
| 10 gsm | Rod pressure | 1.17 | bar | 1.70 | bar |
| 1300 m/min | Rod diameter | 25 | mm | 25 | mm |
| 12 gsm | Rod pressure | 0.75 | bar | 2.42 | bar |
| 1500 m/min | Rod diameter | 25 | mm | 15 | mm |
| 10 gsm | Rod pressure | 1.43 | bar | 2.00 | bar |

*Not an embodiment of the invention.

For this example, the color with 0.07 parts POLYOX WSR 1105 is more uniformly distributed over the film press roll, per visual assessment.

### Examples 4 and 5

### Blade Coating; Influence of POLYOX WSR 1105 on Blade Pressures and Coat Weights

Examples 4 and 5 illustrate the positive impact of POLYOX WSR on coat weight increase for constant blade loading angle.

References are colors F12 and F13, which do not contain any specific component designed for allowing higher coat weights. CMC is used in order to adjust the shear viscosity of the color.

Color F17 is a reference color formulated in order to reach higher coat weights and is formulated according to the state of the art in that it contains 0.05 part (dry/dry) of STEROCOLL BL.

Colors F14, F15 and F16 are formulated according to the present invention and contain 0.05 part of POLYOX WSR 1105.

For the specified coating speeds, these colors are run in 2 modes. At constant blade loading angle the influence of color formulation on resulting average coat weight and cross direction profile is considered. At fixed average coat weight the blade loading angle needed to reach the targeted coat weight is determined. If needed, the coating head angle is also varied in case at maximum load angle (25°) the coat weight is still above target.

The scope of the invention is best illustrated by the trials for the case of a low fixed blade loading angle. In practice, the maximum coat weight is reached for the lowest runnable blade loading angle, which for the coater used in this example is 8°.

Example 4 considers coating on a 42 gsm LWC base paper (Base Paper B). Example 5 considers the case of blade coating on a precoated base (Base Paper C). The results of Examples 4 and 5 are summarized in Tables 4 and 5, respectively.

### Example 4

### LWC Blade Coating

TABLE 4

| | F12* | F13* | F14 | F15 | F16 | F17* |
|---|---|---|---|---|---|---|
| CARBONATE (B) | 80 | 80 | 80 | 80 | 80 | 80 |
| CLAY (B) | 20 | 20 | 20 | 20 | 20 | 20 |
| CMC | 0.15 | 0.15 | 0.15 | 0.15 | 0.15 | 0.15 |
| PVOH | 0.8 | 0.8 | 0.8 | 0.8 | 0.8 | 0.8 |
| LATEX (B) | 11 | 11 | 11 | 11 | 11 | 11 |
| TINOPAL ABP/Z | 0.6 | 0.6 | 0.6 | 0.6 | 0.6 | 0.6 |
| POLYOX WSR 1105 | 0 | 0 | 0.05 | 0.05 | 0.05 | |
| STEROCOLL BL | | | | | | 0.05 |
| Coating solids (%) | 66.1 | 64 | 66.1 | 64.2 | 62.1 | 66 |
| pH | 8.5 | 8.6 | 8.6 | 8.5 | 8.5 | |
| Viscosity (cP) | 630 | 400 | 630 | 430 | 310 | |

Applied coat weight (gsm), as function of blade loading angle
Stiff blade - Blade loading angle is fixed - and resulting coat weight is measured

| | | | | | | | |
|---|---|---|---|---|---|---|---|
| 1400 m/min | Blade loading | 21.5 | 13.8 | 30 | 20.7 | 14.1 | 23 |
| | angle 8° | | | | | | |
| | Blade loading | 12.3 | 8.3 | 18 | 13.5 | 8.9 | 14 |
| | angle 16° | | | | | | |
| | Blade loading | 6.8 | 5.2 | 12.3 | not run | not run | 9.2 |
| | angle 24° | | | | | | |
| 1000 m/min | Blade loading | 8.1 | 6.1 | 13.2 | 11 | 6.9 | 9.4 |
| | angle 16° | | | | | | |
| 800 m/min | Blade loading | 7.0 | 5.6 | 11.1 | 9.3 | 7.2 | not run |
| | angle 16° | | | | | | |

Blade loading angle and coating head angle as function of coat weight
Target coat weight is fixed, the required blade loading angle (in degrees)
is determined (figures in parentheses are the coating head angle)

| | | | | | | | |
|---|---|---|---|---|---|---|---|
| 1400 m/min | CW = 12 gsm | 20.8° (45°) | not run | not run | not run | not run | not run |
| | CW = 15 gsm | 14.3° (45°) | not run | 24.5° (45°) | not run | not run | not run |
| | CW = 18 gsm | 15° (40°) | not run | 20.3° (45°) | not run | not run | not run |
| | CW = 20 gsm | 10.2° (35°) | not run | 17° (45°) | not run | not run | not run |

*Not an embodiment of the invention.

By using POLYOX WSR 1105 at 0.05 part in a coating color the hydrodynamic pressure on the blade can be surprisingly increased, resulting: (1) for a same target coat weight, in a higher blade loading angle; or (2) for a same blade loading angle, in a much higher coat weight.

For a fixed speed, at 8° blade loading angle (lowest blade loading angle), color F14 with 0.05 part POLYOX WSR 1105 (according to invention) gives a coat weight higher by 30% versus color F17 formulated accordingly to the existing state of the art

In case of high target coat weight, using 0.05 part POLYOX WSR 1105 results in better control of the cross direction profile and reducing/avoiding wet bleeding.

The increase of hydrodynamic pressure on the blade in blade coating is consistent with the increase of rod pressure in the case of film press coating.

### Example 5

### Blade Coating on Precoated Paper

TABLE 5

| | |
|---|---|
| F12* | F14 |

Applied coat weight (gsm), as function of blade loading angle
Blade loading angle is fixed - and resulting coat weight is measured

| | | | |
|---|---|---|---|
| 1300 m/min | Blade loading angle 8° | 15.6 | 21.2 |
| | Blade loading angle 16° | 9.3 | 13.9 |
| | Blade loading angle 24° | 6.1 | 10.1 |

*Not an embodiment of the invention.

By using POLYOX WSR 1105 at 0.05 part in a coating color the hydrodynamic pressure on the blade is very much increased, resulting: (1) for a same target coat weight, in a higher blade loading angle, or (2) for a same blade loading angle, in a much higher coat weight.

For a fixed speed, at 8° blade loading angle (lowest blade loading angle), color F14 with 0.05 part POLYOX WSR 1105 (according to invention) gives a coat weight higher by 35% versus color F12.

In case of high target coat weight, using 0.05 part POLYOX WSR 1105 results in better control of the cross direction profile and reducing/avoiding wet bleeding.

### Example 6

### Film Press Coating; Effect of Poly(ethylene oxide)s of Various Molecular Weights at Constant Running Conditions

TABLE 6

| | F18* | F19* | F20* | F21 | F22 | F23 | F24 | F25 |
|---|---|---|---|---|---|---|---|---|
| CARBONATE (A) | 100 | 100 | 100 | 100 | 100 | 100 | 100 | 100 |
| LATEX (B) | 11 | 11 | 11 | 11 | 11 | 11 | 11 | 11 |
| CMC | 0.3 | 0.3 | 0.3 | 0.3 | 0.3 | 0.3 | 0.3 | 0.3 |
| OBA | 0.8 | 0.8 | 0.8 | 0.8 | 0.8 | 0.8 | 0.8 | 0.8 |
| STEROCOLL BL | | 0.035 | 0.07 | | | | | |
| POLYOX WSR 1105 | | | | 0.05 | | | | |
| POLYOX WSR 205 | | | | | 0.05 | | | |
| POLYOX WSR N-3000 | | | | | | 0.05 | | |
| POLYOX WSR N-80 | | | | | | | 0.05 | |
| POLYOX WSR N-10 | | | | | | | | 0.05 |
| pH | 9 | 9 | 9 | 9 | 9 | 9.1 | 9 | 9 |
| Coating solids (%) | 69 | 69 | 69 | 69.2 | 69.1 | 69.1 | 69 | 69 |
| Br. Viscosity 100 rpm (mPas) | 740 | 810 | 930 | 810 | 840 | 820 | 800 | 800 |

Applied coat weight (gsm) as function of POLYOX Molecular Weight and STEROCOLL BL
Rod pressure is fixed at maximum level and resulting total coat weight is measured

| | | | | | | | | | |
|---|---|---|---|---|---|---|---|---|---|
| Running | Total CW (gsm) | 5.3 | 15.9 | 22.4 | 28.2 | 28.8 | 25.0 | 16.7 | 11.4 |
| conditions | on both sides | | | | | | | | |
| speed 1000 m/min | CW max | 5.9 | 17.1 | 23.3 | 29.1 | 29.8 | 26.4 | 17.6 | 12.0 |
| rod diameter | CW min | 4.5 | 13.3 | 20.3 | 26.7 | 28.1 | 22.8 | 15.2 | 10.3 |
| 25 mm rod | Delta | 1.4 | 3.8 | 3.0 | 2.4 | 1.7 | 3.6 | 2.4 | 1.8 |
| pressure 3 bar | Profile Index | 0.26 | 0.24 | 0.13 | 0.09 | 0.06 | 0.14 | 0.14 | 0.16 |

*Not an embodiment of the invention.

The “Delta” is the difference between CW max and CW min. The “Profile Index” is calculated by dividing the Delta by the Total Coat Weight. For F21 the Profile Index is 2.4/28.2=0.09. A lower Profile Index indicates a flatter coating profile and a more uniform coating.

Example 6 illustrates the impact of different poly(ethylene oxide) of various molecular weight on the total coat weight applied.

The object of the trial is to apply, via film press, a conventional precoat composition while maintaining flat and stable cross direction coating profiles. Profiles are recorded as average value, and max. and min. value. The difference between the last two values is an indication of the cross direction uniformity of the profiles. For the purposes of the invention, the term “Coat Weight Delta” or “Delta” is the difference, expressed in gsm, between the maximum coat weight and the minimum coat weight for a given coating profile, using coat weights measured according to the method specified above.

Running conditions are maintained fixed for all trials and formulations to have consistent comparisons.

Coating speed is constant 1000 mpm, smooth rods with 25 mm diameter are metering devices, both rod pressures are kept at max level (3 bar) to avoid any kind of profile deterioration. Base paper A is used.

Color F18 is the basic formulation. The total coat weight applied is quite low, despite high running solids.

Color F19 is the reference color for targeting high coat weights and is formulated according to the state of the art, containing 0.035 parts (dry/dry) of a high molecular weight acrylamide/acrylic acid copolymer (Sterocoll BL). The coat weight applied increases significantly up to about 16 gsm and the profiles are good.

Color F20 is similar to F19, but contains double amount of Sterocoll BL. The effect on the coat weight is even higher (23.3 gsm) than before and the profiles are good.

Color F21 contains 0.05 pts of POLYOX WSR 1105. The coat weight applied is significantly higher than the one obtained with state of the art additives, reaching more than 28 gsm. Profiles are extremely flat.

Color F22 contains 0.05 pts of POLYOX WSR 205. The coat weight applied is significantly higher than the one obtained with state of the art additives, reaching more than 28 gsm. Profiles are extremely flat.

Color F23 contains 0.05 pts of POLYOX WSR N-3000. The coat weight applied is significantly higher than the one obtained with state of the art additives, reaching about 25 gsm. Profiles are extremely flat.

Color F24 contains 0.05 pts of POLYOX WSR N-80. The coat weight (17.6 gsm) is still slightly higher than the one obtained with the state of the art additive, at recommended addition level. Profiles are good.

Color F25 contains 0.05 pts of POLYOX WSR N-10. The coat weight drops to 11.4 gsm, with good profiles.

As shown by Example 6, poly(ethylene) oxide modifies the rheology properties of the coating color, allowing a significant increase in the coat weight, at fixed hydrodynamic pressure of the rod.

The molecular weight plays a fundamental role in the invention. Molecular weights as low as 200,000 behave better than the state of the art products. Molecular weight of 600,000 to 900,000 behave significantly better than the state of the art products, also when these are used at double the normal amounts.

1. A coating composition for paper and/or paperboard comprising:
A) 100 weight parts filler and, per 100 weight parts filler expressed as solids,
B) from 3 to 25 weight parts, expressed as solids, of a binder, and
C) from 0.005 to 2 parts by weight of a water-soluble alkylene oxide polymer having a weight average molecular weight of at least 100,000
wherein the composition has a solids content of at least 65%.

2. The composition of claim 1 wherein the water-soluble alkylene oxide polymer has an average molecular weight of at least 400,000.

3. The composition of claim 1 wherein the water-soluble alkylene oxide polymer has an average molecular weight of from 400,000 to 5,000,000.

4. The composition of claim 1 wherein the water-soluble alkylene oxide polymer has an average molecular weight of from 600,000 to 2,000,000.

5. The composition of claim 1 wherein the water-soluble alkylene oxide polymer is a poly(ethylene oxide).

6. The composition of claim 5 wherein the poly(ethylene oxide) has an average molecular weight of at least 400,000.

7. The composition of claim 5 wherein the poly(ethylene oxide) has an average molecular weight of from 400,000 to 5,000,000, and the binder comprises a synthetic latex.

8. A process for preparing coated paper or paperboard, comprising coating a substrate paper or paperboard by a film press process with a paper coating composition comprising:
A) 100 weight parts filler and, per 100 weight parts filler expressed as solids,
B) from 3 to 25 weight parts, expressed as solids, of a binder, and
C) from 0.005 to 2 parts by weight of a water-soluble alkylene oxide polymer having a weight average molecular weight of at least 100,000
wherein the composition has a solids content of at least 65%.

9. The process of claim 8 wherein a coat weight of at least 10 gsm is applied to at least one side of the substrate in a single pass.

10. The process of claim 8 wherein a coat weight of 10 to 20 gsm per side is applied to the substrate in a single pass.

11. The process of any of claim 8 wherein the water-soluble alkylene oxide polymer has an average molecular weight of from 600,000 to 2,000,000

12. The process of claim 11 wherein the water-soluble alkylene oxide polymer has an average molecular weight of from about 800,000 to about 1,000,000.

13. The process of any of claim 8 wherein the composition has a solids content of at least 66%.

14. The process of claim 13 wherein the composition has a solids content of at least 67%.

15. The process of claim 13 wherein the composition has a solids content of at least 68%.

16. The process of claim 13 wherein the composition has a solids content of at least 69%.

17. The process of claim 8 wherein the substrate velocity is at least 800 m/min. and the process is conducted under conditions such that an average coat weight of at least 28 gsm is applied to the substrate paper or paperboard in a single pass, and the Profile Index is not more than 0.11

18. The process of claim 17 wherein the same or different coating compositions are applied simultaneously to 2 sides of the substrate.

19. The process of claim 17 wherein the degree of misting is less than 0.025 g/m-sec.

20. The process of claim 8 wherein the Profile Index is not more than 0.11.
